(19) United States
(12) Patent Application Publication
(10) Pub. No.: US 2019/0090611 A1
(43) Pub. Date: Mar. 28, 2019

(54) PUMP-TYPE COSMETIC CONTAINER HAVING A SIDE BUTTON

(71) Applicant: YONWOO CO., LTD., Incheon (KR)

(72) Inventors: Hak-Chan Kim, Incheon (KR); Ki-Young Ham, Incheon (KR); Seo-Hui Jung, Incheon (KR)

(21) Appl. No.: 16/078,484

(22) PCT Filed: Jan. 11, 2017
(86) PCT No.: PCT/KR2017/000349

§ 371 Date: Aug. 21, 2018

(30) Foreign Application Priority Data
Feb. 23, 2016 (KR) 10-2016-0021122

(51) Int. Cl. A45D 34/04; B05B 11/00; B65D 83/00; B65D 47/06

(52) U.S. Cl. CPC A45D 34/04; B05B 11/3015; B05B 11/3018; B05B 11/3032; A45D 2034/002; B05B 11/3064; B65D 83/0022; B65D 47/068; B05B 11/3036

(57) ABSTRACT

The present invention relates to a pump-type cosmetic container having a side button, wherein when a user presses a button portion, the button portion is elastically deformed by an elastic force of the button part itself, such that a pumping operation is performed to discharge contents, which makes it possible to easily discharge the contents by means of a simple structure with no separate pumping member, thereby reducing an assembling time and manufacturing cost.

### BACKGROUND OF THE INVENTION

The present invention relates to a pump-type cosmetic container having a side button, wherein when a user presses a button portion, the button portion is elastically deformed by an elastic force of the button part itself, such that a pumping operation is performed to discharge contents, which makes it possible to easily discharge the contents by means of a simple structure with no separate pumping member, thereby reducing an assembling time and manufacturing cost.

Generally, a pump-type of cosmetics container is configured to discharge contents to the outside by a pumping operation of a pumping member, comprising: a container body where contents are received, a pumping member coupled to an upper portion of the container body and moving the contents received in the container body by the pumping operation to an upper portion thereof, and a button part, coupled to an upper portion of the pumping member and delivering the pressure to the pumping member according to user's pressurization, further including a contents discharge hole at one side thereof to discharge contents.

The pump-type container in the above is configured in a way that the pressure of the interior of a cylinder having a pumping member is generated when a user pressurizes the button part, and thus, the contents stored in the container body are discharged in a fixed quantity through a content discharge hole by the pressure. Since this type of traditional pump-type container is configured in a way that a pumping member and a button part are disposed directly above the container body where contents are stored such that contents can be discharged by the button part ascending and descending, it is hard for a user to apply contents exactly on the desired region because the contents discharge hole formed on one side of the button part moving upward and downward, and therefore, the user should discharge the contents on her hand and then apply them on her skin.

To solve the problems in the above, recently pumping-type containers are widely being manufactured wherein an applicator is installed on the upper portion thereof and provided with a button part on the side thereof, such that, when the button part is manipulated, contents can be discharged through the applicator for being used.

A pump-type container with a side button in the above is disclosed in the Korean Patent No. 10-1464191 (hereafter is called as the registered patent).

The registered patent includes: a container body wherein contents are held; a cylinder part, placed at an upper portion of the container body and forming a passage where contents move, further comprising a cylinder body which is placed toward a side surface for being crossed at a right angle to the container body, a contents inflow tube which extends to a lower portion of the cylinder body, forming a contents inflow hole which leads the contents contained in the container body to flow into an interior of the cylinder body, and a content outflow tube which extends to an upper portion of the cylinder body, further forming a contents outflow hole wherein the contents flowing to an interior of the cylinder body can flow out; a pumping member which is inserted to an interior of the cylinder body and discharges contents by changing inner pressure of the cylinder body by a pumping movement; a button part which is combined to the pumping member and delivers pressure to the pumping member by a pressing movement; and an applicator which forms a contents discharging hole so that a user can discharge contents through the contents outflowing hole and thereby apply contents discharged outward onto a skin,

wherein the pumping member is composed of: a piston rod moving inside the cylinder body; a seal cap coupled encircling an outer circumferential surface of the piston rod and moves in a state of being contacted to an inner wall of the cylinder body; a stem fixedly installed at inner side of the button part and coupled to the piston rod, thereby delivering the pressure generated by pressing the button part to the piston rod; and a spring installed encircling an outer circumferential surface of the stem from the outside of the cylinder body, contracted when the button part is pressurized, when the button part is released, and providing an elastic force to the stem, thereby restoring the button part,

wherein the piston rod is characterized in a way that to prevent interference occurring in a process of the contents moving to a content outflow hole by a pumping operation of the pumping member, the end of the piston rod which moves inside the cylinder body has a stroke distance with a range of not covering the whole of the contents inflow hole and the contents outflowing hole.

However, the registered patent, as in the above, has a configuration wherein a pumping member which performs a pumping operation is provided to discharge the contents stored in the container body. It has such a complicated structure of the pumping member as a piston rod, a seal cap, a stem, and a spring. Therefore, to install such a complicated pumping member, the assembly time increase and the manufacturing cost of the container gets higher, which eventually leads users a cost burden.

### SUMMARY OF THE INVENTION

The present invention is derived to solve the problems described in the above and to provide a pump-type cosmetic container having a side button wherein when a user presses a button portion, the button portion is elastically deformed by an elastic force of the button part itself, such that a pumping operation is performed to discharge contents, which makes it possible to easily discharge the contents by means of a simple structure with no separate pumping member, thereby reducing an assembling time and manufacturing cost.

To solve the problems in the above, a pump-type cosmetic container having a side button according to the present invention is characterized to include: a container body storing contents and provided with a discharge part for the stored contents to be discharged through; a support body coupled as encasing the discharge part, and having a contents movement hole formed therein for the contents stored in the container body to move through; a cylinder part, coupled to the support body and formed with a passage therein which contents move through, further formed with a cylinder body disposed toward the side surface to be met at a right angle with the support body, a contents inflow tube provided with a contents inflow hole such that the contents stored in the container body can flow to the inside the cylinder body, and a contents outflow tube extending toward the upper portion of the cylinder body and formed with a contents outflow hole such that the contents flowing to the inside of the cylinder body can flow through; a button part coupled to the cylinder body and changing the inner pressure of the cylinder body according to user's pressurization; an elastic valve body secured on the upper end of the support body at the inner side of the cylinder part, and selectively opening/closing the contents movement hole and the contents outflow hole while ascending and descending according to the button part being pressurized or not; and a cylinder housing receiving the cylinder part and having an applicator which applies contents onto user's skin secured at the upper end thereof, and formed with an insertion hole at the side surface thereof such that the button part can be exposed to the outside.

Furthermore, it is characterized to include: a container body storing contents and provided with a discharge part for the stored contents to be discharged through; a support body coupled as encasing the discharge part and formed with a contents movement hole for a support body coupled as encasing the discharge part, and having a contents movement hole formed therein for the contents stored in the container body can move through; a cylinder part, coupled to the support body and formed with a passage therein which contents move through, and further formed with a cylinder body disposed toward the side surface to be met at a right angle with the support body, a contents inflow tube provided with a contents inflow hole such that the contents stored in the container body can flow to the inside the cylinder body, and a contents outflow tube extending toward the upper portion of the cylinder body and formed with a contents outflow hole such that the contents flowing to the inside of the cylinder body can flow through; a button part coupled to the cylinder body and changing the inner pressure of the cylinder body according to user's pressurization; an elastic valve body secured on the upper end of the support body at the inner side of the cylinder part, and selectively opening and closing the contents movement hole and the contents outflow hole while ascending and descending according to the button part being pressurized or not; and a cylinder housing receiving the cylinder part and having a nozzle part, which discharges contents, equipped at the upper end thereof, and having an insertion hole formed at the side surface thereof such that the button part can be exposed to the outside.

Furthermore, it is characterized in that the elastic valve body, made of elastic material, includes an opening/closing plate secured on the upper end of the support body and opening/closing the contents movement hole according to the pressurization of the button part, and an opening/closing rod extending toward the upper portion at the center part of the opening/closing plate and opening/closing the contents outflow hole according to the pressurization of the button part.

Furthermore, it is characterized in that a valve securing part, protrusively formed toward the upper portion thereof as encasing the contents movement hole and having an opening/closing plate of the elastic valve body secured, is provided at the upper end of the support body.

Furthermore, it is characterized in that, when the button part is pressurized, the opening/closing plate is pressed in a downward direction by the pressure of contents flowing to the cylinder part and closely contacted to the upper surface of the valve securing part, thus maintaining the closing state of the contents movement hole. As the center part of the opening/closing plate is elastically being deformed in a downward direction by the pressure of the contents, the opening/closing rod descends, thus making the contents outflow hole open.

Furthermore, it is characterized in that, when the button part is released from being pressurized, the deformed center part of the opening/closing plate is restored by the pressure change of the cylinder part and thus, the opening/closing rod ascends to make the contents outflow hole closed, causing the opening/closing plate to be separated from the upper surface of the valve securing part and inducing the contents movement hole to open.

Furthermore, it is characterized in that the button part comprises a coupling part coupled to the cylinder body, and a pressurization part, made of elastic material, disposed at the dead end of the coupling part, and having its shape deformed by user's pressurization.

Furthermore, it is characterized in that the button part includes a separation preventing cap which encases the coupling part of the button part and is coupled to the cylinder body and prevents the button part from being separated.

Furthermore, it is characterized in that a coupling groove which the coupling part of the button part is coupled to such that the button part and the separation preventing part are respectively fixed therein, and a fixation protrusion which fixes the separation preventing cap are provided at the cylinder body

Furthermore, it is characterized in that the button part is configured with: a button body; a piston housing coupled to the piston body; a piston disposed in a state of being closely contacted to the inner wall of the piston housing at the inner side of the piston housing and moves according to the presence/absence of pressurization; a spring disposed between the piston rod and the piston housing and restoring the button body.

Furthermore, it is characterized in that at the upper surface of the support body are protrusively installed a pair of projections whose shapes are different each other to give the directional nature when being assembled and to make the cylinder part fixed, and that at the outer circumferential surface of the contents inflow tube are equipped a pair of coupling protrusions that correspond to the pair of projections.

As described in the above, according to the present invention, when a user pressurizes a button part, the button part is elastically deformed by an elastic force of the button portion itself, such that a pumping operation is performed to discharge contents, thereby making it possible to easily discharge contents by means of a simple structure with no separate pumping member.

Furthermore, the present invention has a simple structure wherein an elastic valve body ascends/descends at the inner side of the cylinder body according to pressurization of the button part and selectively opens/closes the contents movement hole and the contents outflow hole, thereby making it possible to improve productivity due to the reduction of assembly time.

### BRIEF DESCRIPTION OF THE DRAWINGS

FIG. 1 is an exploded perspective view illustrating a configuration of a pump-type cosmetic container having a side button according to the first exemplary embodiment of the present invention.

FIG. 2 is an assembled perspective view illustrating a configuration of a pump-type cosmetic container having a side button according to the first exemplary embodiment of the present invention.

FIG. 3 is an assembled cross-sectional view illustrating a configuration of a pump-type cosmetic container having a side button according to the first exemplary embodiment of the present invention.

FIG. 4 is an explanatory view illustrating a configuration of coupling a support body and a cylinder part of the pump-type cosmetic container having a side button according to the first exemplary embodiment of the present invention.

FIGS. 5 and 6 are operational states of a pump-type cosmetic container having a side button according to the first exemplary embodiment of the present invention.

FIG. 7 is an assembled cross-sectional view illustrating a configuration of a pump-type cosmetic container having a side button according to the second exemplary embodiment of the present invention.

FIG. 8 is an assembled cross-sectional view illustrating a configuration of a pump-type cosmetic container having a side button according to the third exemplary embodiment of the present invention.

### DETAILED DESCRIPTION OF PREFERRED EMBODIMENTS

Hereinafter, exemplary embodiments of the present invention will be described in detail with reference to the accompanying drawings. The same reference numerals provided in the drawings indicate the same members.

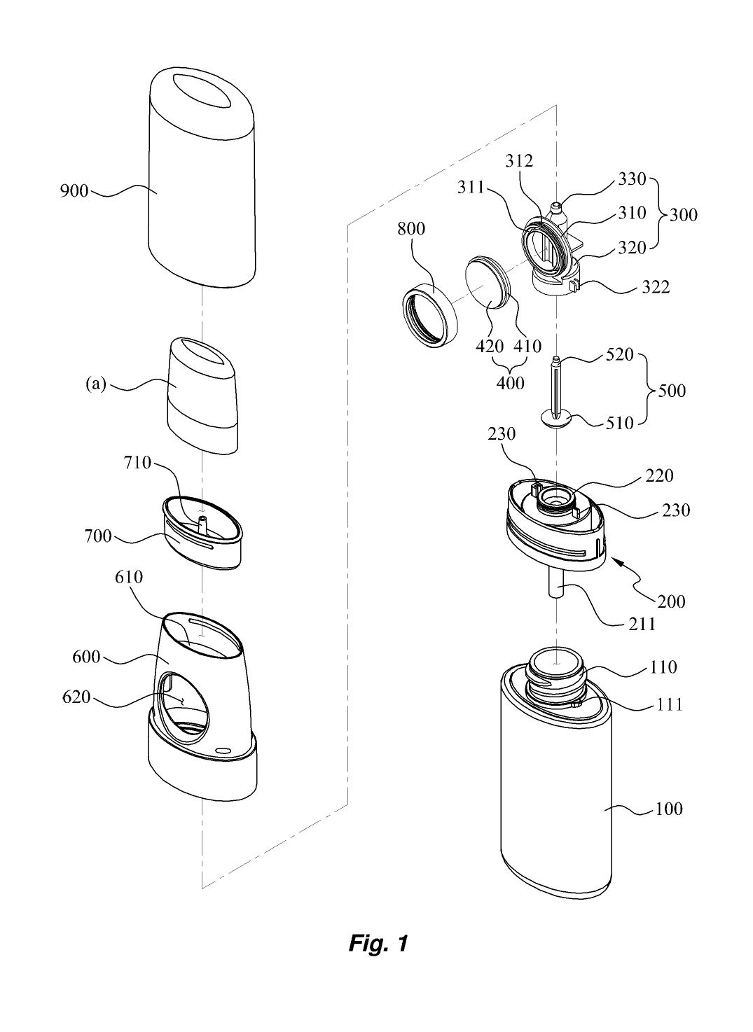

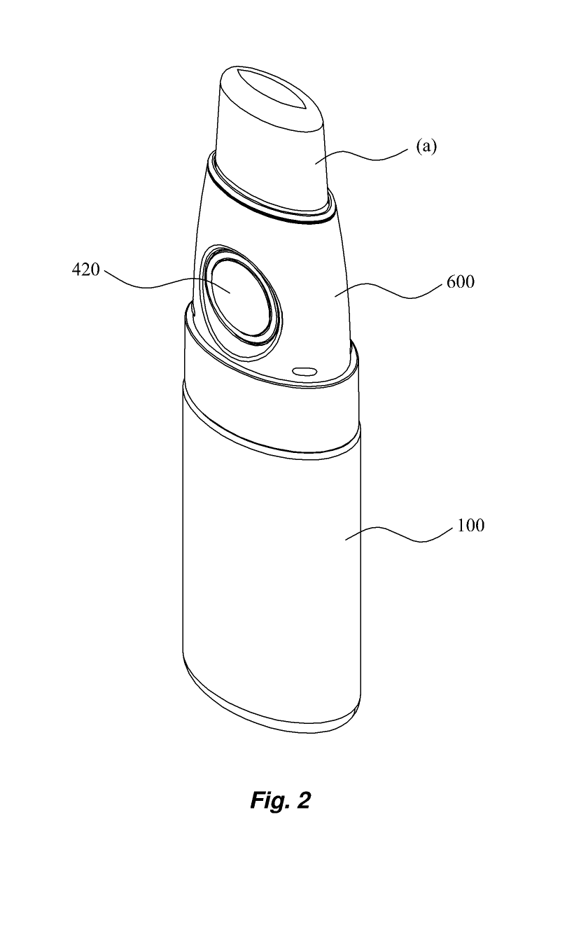

FIG. 1 is an exploded perspective view illustrating a configuration of a pump-type cosmetic container having a side button according to the first exemplary embodiment of the present invention. FIG. 2 is an assembled perspective view illustrating a configuration of a pump-type cosmetic container having a side button according to the first exemplary embodiment of the present invention.

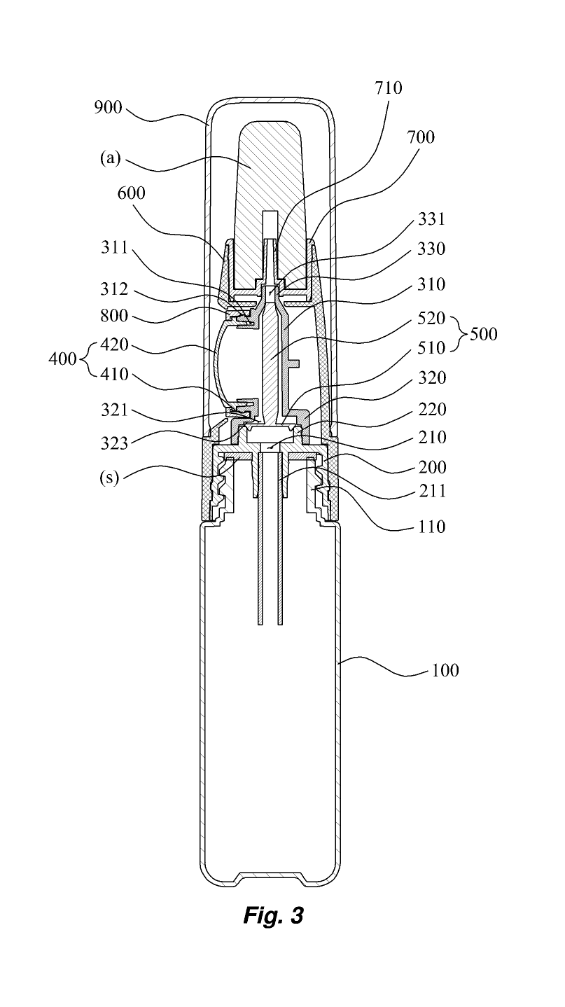

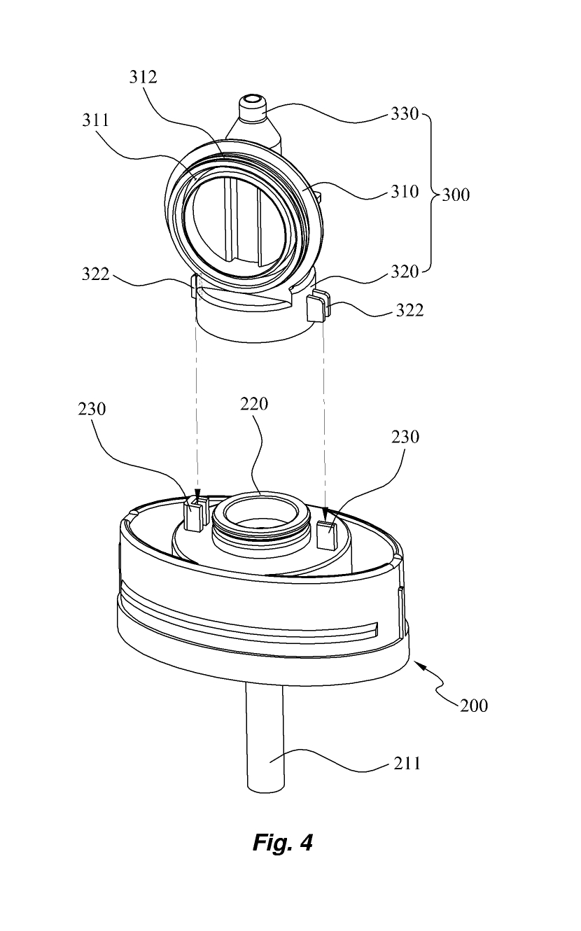

FIG. 3 is an assembled cross-sectional view illustrating a configuration of a pump-type cosmetic container having a side button according to the first exemplary embodiment of the present invention. FIG. 4 is an explanatory view illustrating a configuration of coupling a support body and a cylinder part of the pump-type cosmetic container having a side button according to the first exemplary embodiment of the present invention.

Referring to FIGS. 1 to 4, a pump-type cosmetic container having a side button according to an exemplary embodiment of the present invention includes a container body 100, a support body 200, a cylinder part 300, a button part 400, an elastic valve body 500, and a cylinder housing 600.

The container body 100, where contents are stored, is provided with a discharge part 110 at the upper portion thereof, wherein it is preferable to have a sealing member (S) installed at the upper end of the discharge part 110 such that the sealing member (S), coupled to the lower end of the support body 200, can prevent contents from being leaked through a space between the discharge part 110 and the support body 200.

The support body 200, coupled as encasing the upper portion of the discharge part 110, has a contents movement hole 210 formed to make the contents stored in the container body 100 move to the inside of the cylinder part 300 during the pumping operation, wherein it is preferable to install a contents suction tube 211, which suctions the contents stored in the container body 100, at the lower portion of the contents movement hole 210.

Furthermore, at the upper end of the support body 200 is provided a valve securing part 220 which is protrusively provided as encasing the contents movement hole 210 and which an opening/closing plate 510 of an elastic valve body 500 is secured to. The valve securing part 220 has a cylindrical shape protruding upward, which allows the center portion of an opening/closing plate 510 to make a space in a downward direction which can be elastically deformed by the pressure of contents.

Meanwhile, a pair of protrusions 230 are provided at the upper surface of the support body 200 to fix the cylinder part 300, wherein the protrusions 230 are characterized to provide the directional nature when the cylinder part 300 are assembled such that the cylinder body 310 can be assembled only to the direction of an insertion hole 620.

The protrusion 230, as illustrated in FIG. 4, is configured to be assembled in one direction when coupled with a coupling protrusion 322 of the cylinder part 300 because each of a pair of protrusions 230 has a different shape respectively. Moreover, each of coupling protrusions 322 also has a shape which respectively corresponds to each of protrusions 230.

The cylinder part 300, forming a passage which is coupled to the upper portion of the support body 200 and where contents move, includes a cylinder body 310, a contents inflow tube 320, and a contents outflow tube 330.

The cylinder body 310 forms a space where an elastic valve body 500 to be described later is operated, wherein the cylinder body 310 in the present invention is characterized to be disposed toward the side surface thereof to be met in a right angle with the container body 100.

Since the cylinder body 310 is disposed toward the side surface to be met in a right angle with the container body 100, it is possible that the button part 400 can be installed at the side surface, not directly above the container body 100, and thus, a coupling groove 311 is formed at the side surface of the cylinder body 310 for the button part 400 to be coupled therein.

Furthermore, a separation preventing cap 800 is coupled to the cylinder body 310 to prevent the cylinder body 310 from being separated from the cylinder body 310, wherein the separation preventing cap 800 is coupled to a fixation protrusion 312 of the cylinder body 310 as encasing the coupling part 410 of the button part 400 and prevents the button part 400 from being separated.

The contents inflow tube 320 extends to the lower portion of the cylinder body 310 and is coupled with the support body 200 which closes the upper portion of the container body 100. A contents inflow hole 321 is provided therein such that the contents moving through the contents movement hole 210 can flow to the inside of the cylinder body 310 when an elastic valve body 500 opens the contents movement hole 210 by the pumping operation according to manipulating the button part 400.

Furthermore, at the outer circumferential surface of the contents inflow tube 320 are coupling protrusions 322 which correspond to respectively to each of a pair of protrusions 230 of the support body 200.

Furthermore, projections 323 are formed at the inner side of the contents inflow tube 320 to be able to limit the ascent of the opening/closing plate 510 of the elastic valve body 500 when ascending.

The contents outflow tube 350, extending to the upper portion of the cylinder body 310 and discharging the contents flowing into the interior of the cylinder body 310 to the outside, is provided with a contents outflow hole 331 which is communicated with a discharge outlet 710 such that the contents flowing into the interior of the cylinder body 310 can move to the applicator.

The button part 400, coupled to the cylinder body 310 of the cylinder part 300 and coupled toward the side surface to be met with the container body 100 in a right angle, discharges the contents flowing into the inside of the cylinder part 300 by being elastically deformed according to user's pressurization and thus, changing the inner pressure of the cylinder part 300. In the present invention, the button part 400 is characterized to have a coupling part 410 coupled to the coupling groove 311 of the cylinder body 300, and a pressurization part 420, made of elastic material, which is disposed at the dead end of the coupling part 410 and whose shape is changed according to user's pressurization.

The pressurization part 420 functions of discharging the contents flowing to the cylinder part 300 in a way that the entire part of the pressurization part 420 moves forward when a user pressurizes the pressurization part 420, and then restores when the user releases the pressurization part 420, thereby changing the inner pressure of the cylinder part 300 and inducing pumping operation.

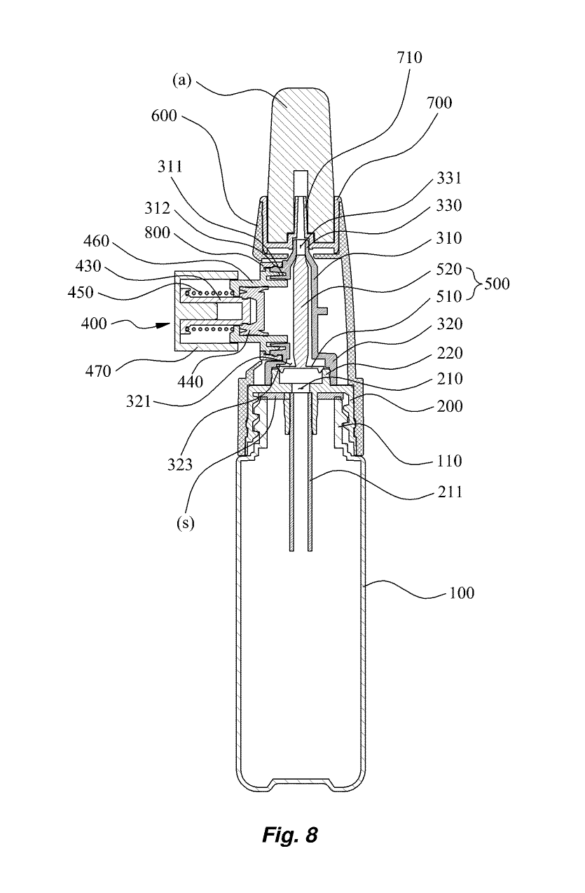

In the present invention, it was described that the button part 400 is made of elastic material and changes the inner pressure of the cylinder part 300 by the elastic deformation. However, as illustrated in FIG. 8, it is possible for the cylinder part 300 to change the inner pressure of the cylinder part 300 by coupling a piston housing 460 to the cylinder body 310 and by installing a piston 440, at the inner side of the piston housing 460, which moves in a state of being closely contacted along the inner wall of the cylinder part 300 according to pressurization of the button body 470. In this case, a piston rod 430 which supports the piston 440 is coupled to the inner side of the button body 470, and a spring 450 to restore the button body 470 is installed between the piston rod 430 and the piston housing 460.

As shown in the above, if the button part 400 comprises a piston rod 430, a piston 440, a spring 450, a piston housing 460, and a button body 470, it is preferable to have a configuration wherein a separation preventing cap 800 is coupled as encasing the piston housing 460 to prevent the button part 400 from being separated.

The elastic valve body 500, which is placed at the inner side of the cylinder part 300 and selectively opens/closes the contents movement hole 210 and the contents outflow hole 331 while ascending/descending according to pressurization of the button part 400, is secured on a valve securing part 220 and comprises an opening/closing plate 510 which opens/closes the contents movement hole 210 according to the pressurization of the button part 400, and an opening/closing rod 520 which extends to the upper portion from the center of the opening/closing place 510 and opens/closes the contents outflow hole 331 according to the pressurization of the button part 400.

The elastic valve body 500 is configured to be pressurized to the downward direction by the pressure of the contents flowing from the cylinder part 300 when the button part 400 is pressurized. Due to this, the opening/closing plate 510 is closely contacted to the upper end of the valve securing part 220 and makes the closing state of the contents movement hole 210 maintained. Meanwhile, the opening/closing rod 520 descends, with the center portion of the opening/closing plate 510 getting elastically deformed to the downward direction, and thereby opens the contents outflow hole 331.

Furthermore, the elastic valve body 500 is configured in a way that the opening/closing rod 520 ascends and closes the contents outflow hole 331, as the center portion of the opening/closing plate 510, which have been elastically deformed, is restored by the pressure change of the cylinder part 300. Simultaneously, the opening/closing plate 510 is separated from the upper surface of the valve securing part 220 and opens the contents movement hole 210.

The opening/closing plate 510 is made of elastic material for being capable of being elastically deformed according to pressurization of the button part 400.

The cylinder housing 600, which is coupled to the upper portion of the container body 100 and supports an applicator (a), is provided with a securing groove 610 where the applicator (a) is secured at the upper portion thereof, and an insertion hole 620 where the button part 400 is inserted and exposed to the outside, wherein the applicator (a) can be made of various material, such as a roller, a brush, a sponge, etc. for being able to apply contents effectively onto user's skin depending on usage.

Meanwhile, a fixation body 700 which supports the applicator (a) is inserted at the securing groove 610, wherein at the center portion of the fixation body 700 is provided a discharge outlet 710 which is communicated with a contents outflow tube 330 such that the contents flowing out through the contents outflow tube 330 can move to the applicator (a).

Furthermore, a hollow where the contents outflow tube 330 is penetrated is provided at the center portion of the cylinder housing 600 such that the contents flowing out through the contents outflow tube 330 can move to the discharge outlet 710.

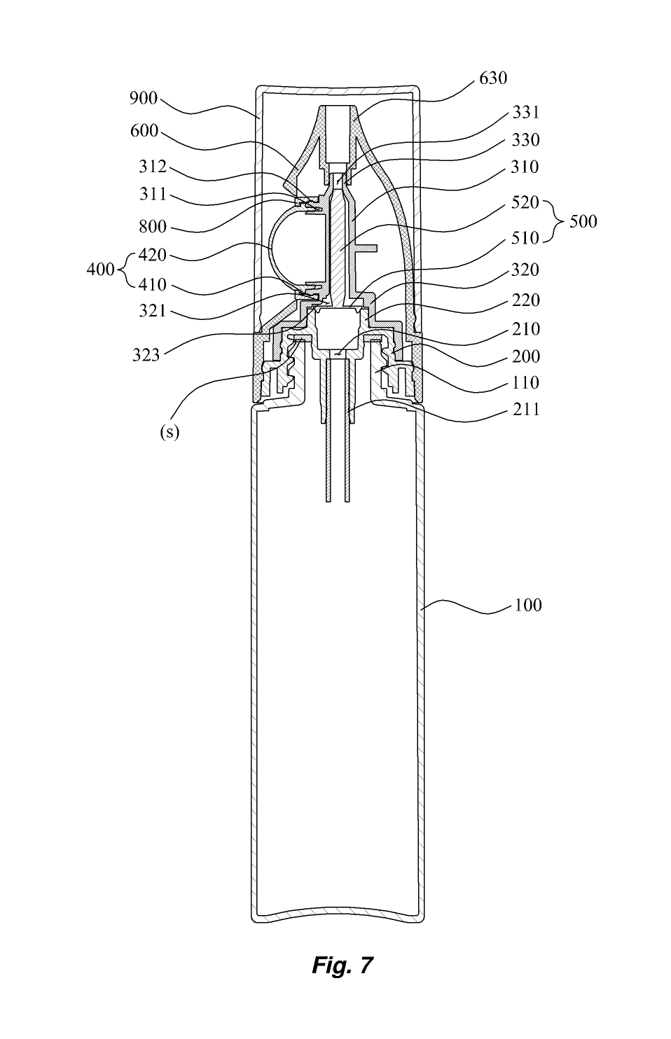

Meanwhile, as illustrated in FIG. 7, it is possible that the cylinder housing 600 according to another exemplary embodiment of the present invention is provided with a nozzle part 630 such that a user can directly discharge contents for use.

The cylinder housing 600 in the present invention is configured to be detachably coupled with an over cap 900 to prevent the applicator (a) from being contaminated or broken and to block foreign matter from entering to the nozzle part 630.

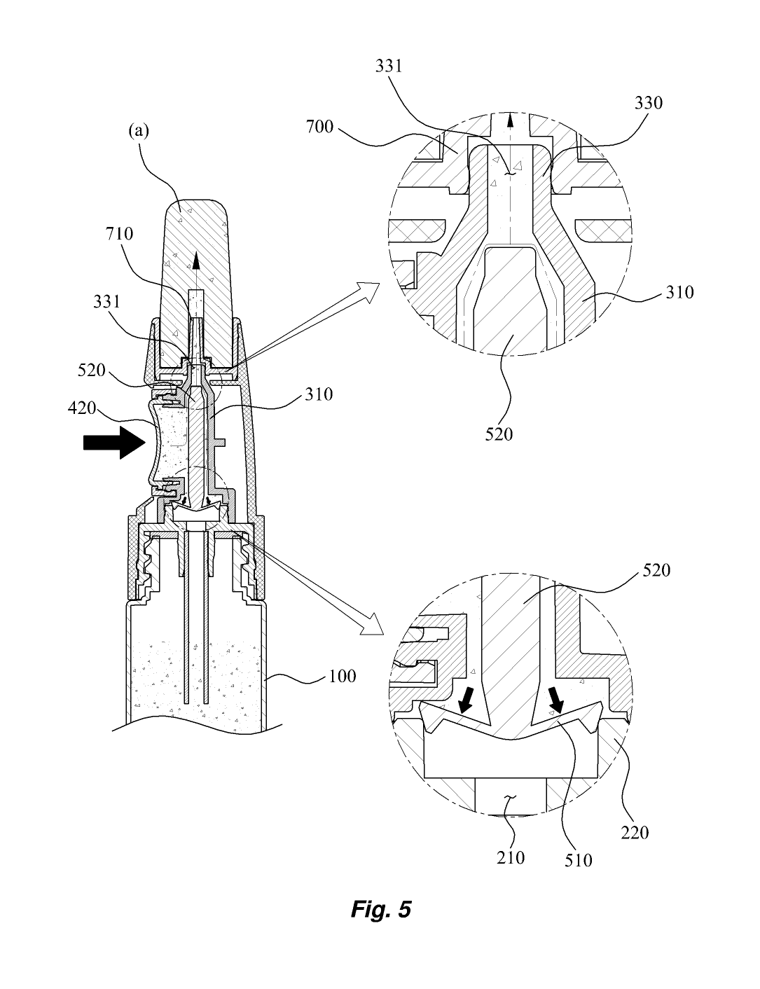

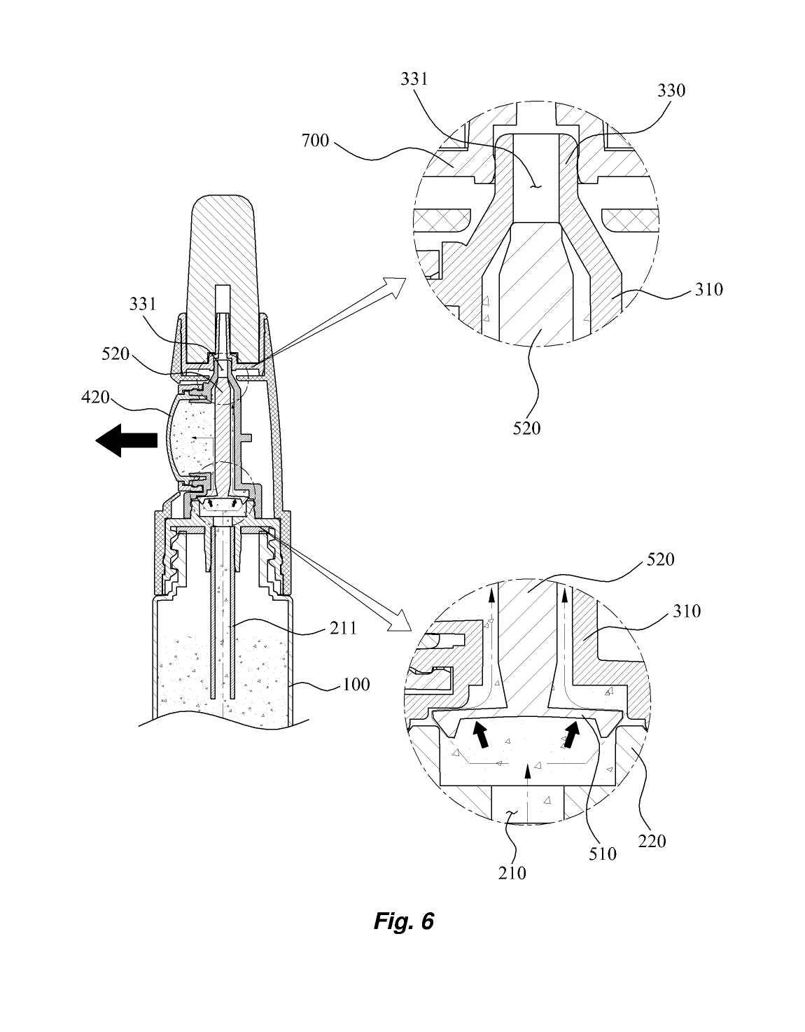

Hereafter, referring to FIGS. 5 to 6, an operational process of a pump-type cosmetic container having a side button according to the first exemplary embodiment of the present invention will be described.

Referring to FIGS. 5 to 6, when a user pressurizes the pressurization part 420, the pressurization part 420, made of elastic material, moves forward by the pressure of the contents flowing into the cylinder body 310. Due to this, the opening/closing plate 510 is closely contacted to the upper end of the valve securing part 220 and maintains the closing state of the contents movement hole 210. In addition, as the center portion of the opening/closing plate 510 is elastically deformed in a downward direction, the opening/closing rod 520 descends, thus making the contents outflow hole 331 opened.

When the pumping operation is performed as in the above, the opening/closing plate 510 is pressurized in a downward direction by the pressure of the contents flowing into the cylinder body 310. Due to this, the opening/closing plate 510 is closely contacted to the upper end of the valve securing part 220 and makes the closing state of the contents movement hole 210 maintained. Meanwhile, as the center portion of the opening/closing plate 510 gets elastically deformed to the downward direction, the opening/closing rod 520 descends and leads the contents outflow hole 331 to be opened.

When the contents outflow hole 331 is opened as described in the above, the contents flowing into the cylinder body 310 move to the applicator (a) after passing through the contents outflow hole 331 and passing by the discharge outlet 710, and then are ready for being applied on the skin.

Meanwhile, when the pressurization part 420 is released from being pressurized, the pressurization part 420 have moved forward by its own elasticity of the pressurization part 420. Due to this, absorption force is generated inside the cylinder part 300, and the center portion of the opening/closing plate 510 have been elastically deformed is restored, thereby causing the opening/closing plate 510 to ascend and then leads the contents outflow hole 331 to be closed. At the same time, the opening/closing plate gets separated from the upper surface of the valve securing part 220, and the contents movement hole 210 opens, thereby leading the contents stored in the container body 100 to flow to the inside of the cylinder part 300 through the contents inflow hole 321.

The present invention, as described in the above, is configured to perform the pumping operation as the pressurization part 420 gets elastically deformed by its own elastic force of the button part 400. It is characterized to improve the productivity due to the assembly time reduction through the configuration wherein the pressurization part 420 ascends/descends at the inner side of the cylinder part 300 according to the pressurization of the button part 400 and selectively opens/closes the contents movement hole 210 and the contents outflow hole 331.

As described above, optimal embodiments have been disclosed in the drawings and the specification. Although specific terms have been used herein, these are only intended to describe the present invention and are not intended to limit the meanings of the terms or to restrict the scope of the present invention as disclosed in the accompanying claims. Therefore, those skilled in the art will appreciate that various modifications and other equivalent embodiments are possible from the above embodiments. Therefore, the technical protective scope of the present invention should be defined by the technical of idea of accompanied claims.

1. A pump-type cosmetic container having a side button, comprising:
a container body storing contents and provided with a discharge part for the stored contents to be discharged through;
a support body coupled as encasing the discharge part, and having a contents movement hole formed therein for the contents stored in the container body to move through;
a cylinder part, coupled to the support body and formed with a passage therein which contents move through, further formed with a cylinder body disposed toward the side surface to be met at a right angle with the support body, a contents inflow tube provided with a contents inflow hole such that the contents stored in the container body can flow to the inside the cylinder body, and a contents outflow tube extending toward the upper portion of the cylinder body and formed with a contents outflow hole such that the contents flowing to the inside of the cylinder body can flow through;
a button part coupled to the cylinder body and changing the inner pressure of the cylinder body according to user's pressurization;
an elastic valve body secured on the upper end of the support body at the inner side of the cylinder part, and selectively opening/closing the contents movement hole and the contents outflow hole while ascending and descending according to the button part being pressurized or not; and
a cylinder housing receiving the cylinder part and having an applicator, which applies contents onto user's skin, secured at the upper end thereof and formed with an insertion hole at the side surface thereof such that the button part can be exposed to the outside.

2. A pump-type cosmetic container having a side button, comprising:
a container body storing contents and provided with a discharge part for the stored contents to be discharged through;
a support body coupled as encasing the discharge part hole and formed with a contents movement part for a support body coupled as encasing the discharge part, and having a contents movement hole formed therein for the contents stored in the container body can move through;
a cylinder part, coupled to the support body and formed with a passage therein which contents move through, and further formed with a cylinder body disposed toward the side surface to be met at a right angle with the support body, a contents inflow tube provided with a contents inflow hole such that the contents stored in the container body can flow to the inside the cylinder body, and a contents outflow tube extending toward the upper portion of the cylinder body and formed with a contents outflow hole such that the contents flowing to the inside of the cylinder body can flow through;
a button part coupled to the cylinder body and changing the inner pressure of the cylinder body according to user's pressurization;
an elastic valve body secured on the upper end of the support body at the inner side of the cylinder part, and selectively opening and closing the contents movement hole and the contents outflow hole while ascending and descending according to the button part being pressurized or not; and
a cylinder housing receiving the cylinder part and having a nozzle part, which discharges contents, equipped at the upper end thereof, and having an insertion hole formed at the side surface thereof such that the button part can be exposed to the outside.

3. The pump-type cosmetic container having a side button of claim 1,
wherein the elastic valve body, made of elastic material, includes an opening/closing plate secured on the upper end of the support body and opening/closing the contents movement hole according to the pressurization of the button part, and an opening/closing rod extending toward the upper portion at the center part of the opening/closing plate and opening/closing the contents outflow hole according to the pressurization of the button part.

4. The pump-type cosmetic container having a side button of claim 3,
wherein a valve securing part, protrusively formed toward the upper portion thereof as encasing the contents movement hole and having an opening/closing plate of the elastic valve body secured, is provided at the upper end of the support body.

5. The pump-type cosmetic container having a side button of claim 4,
wherein when the button part is pressurized, the opening/closing plate is pressed in a downward direction by the pressure of contents flowing to the cylinder part and closely contacted to the upper surface of the valve securing part, thus maintaining the closing state of the contents movement hole. As the center part of the opening/closing plate is elastically being deformed in a downward direction by the pressure of the contents, the opening/closing rod descends, thus making the contents outflow hole open.

6. The pump-type cosmetic container having a side button of claim 5,
wherein when the button part is released from being pressurized, the deformed center part of the opening/closing plate is restored by the pressure change of the cylinder part and thus, the opening/closing rod ascends to make the contents outflow hole closed, causing the opening/closing plate to be separated from the upper surface of the valve securing part and inducing the contents movement hole to open.

7. The pump-type cosmetic container having a side button of claim 1,
wherein the button part comprises a coupling part coupled to the cylinder body, and a pressurization part, made of elastic material, disposed at the dead end of the coupling part, and having its shape deformed by user's pressurization.

8. The pump-type cosmetic container having a side button of claim 7,
wherein the button part includes a separation preventing cap which encases the coupling part of the button part and is coupled to the cylinder body and prevents the button part from being separated.

9. The pump-type cosmetic container having a side button of claim 8,
wherein a coupling groove which the coupling part of the button part is coupled to such that the button part and the separation preventing part are respectively fixed therein, and a fixation protrusion which fixes the separation preventing cap are provided at the cylinder body.

10. The pump-type cosmetic container having a side button of claim 1,
wherein the button part is configured with: a button body; a piston housing coupled to the cylinder body; a piston disposed in a state of being closely contacted to the inner wall of the piston housing at the inner side of the piston housing and moves according to the presence/absence of pressurization; a spring disposed between the piston rod and the piston housing and restoring the button body.

11. The pump-type cosmetic container having a side button of claim 1,
wherein at the upper surface of the support body are protrusively installed a pair of projections whose shapes are different each other to give the directional nature when being assembled and to make the cylinder part fixed, and that at the outer circumferential surface of the contents inflow tube are equipped a pair of coupling protrusions that correspond to the pair of projections.
